(19) United States
(12) Patent Application Publication
(10) Pub. No.: US 2026/0147686 A1
(43) Pub. Date: May 28, 2026

(54) LOW ENTROPY APPROACH FOR ALIGNING GENERATIVE PROCESSES WITH HUMAN PREFERENCES

(71) Applicant: Dell Products L.P., Round Rock, TX (US)

(72) Inventors: Werner Spolidoro Freund, Rio de Janeiro (BR); João Victor da Fonseca Pinto, Rio de Janeiro (BR); Micael Veríssimo de Araújo, Rio de Janeiro (BR)

(21) Appl. No.: 18/962,092

(22) Filed: Nov. 27, 2024

(51) Int. Cl. G06F 11/34

(52) U.S. Cl. CPC G06F 11/3409; G06F 2201/80

(57) ABSTRACT

Aligning generative systems and processes to user preferences is disclosed. A curated dataset that includes question/answer (QA) pairs is generated from a source. The QA pairs include a question, a squashing instruction, and an RPI. The QA pairs are subject to a feedback loop, which may include user input. The QA pairs, when curated, reflect final user preferences. The alignment of a generative system to the final user preferences can be measured and/or tracked using the curated dataset in a repeatable and automated verification operation. The answers generated by the generative system to the QA pairs can be compared with the RPIs to determine a correctness of the answer in the verification method. A cumulative score for all of the QA pairs represents how aligned the generative system is to the final user preferences. This allows modifications to be made to align the generative system with desired user preferences.

### TECHNOLOGICAL FIELD OF THE DISCLOSURE

Embodiments disclosed herein generally relate to aligning generative systems. More particularly, at least some embodiments relate to systems, hardware, software, computer-readable media, and methods for aligning generative machine learning/artificial intelligence with user preferences.

### BACKGROUND

Retrieval augmented generation (RAG), a form of a generative system, typically includes a retriever and a generator (e.g., a large language model (LLM)). The RAG system, when presented with a question (or query), uses the question to identify data from knowledge sources. That data identified and retrieved by the retriever is used as context for a prompt submitted to the LLM. In a RAG system, the LLM may be constrained such that answer to the query should not deviate from the content given as input. RAG systems help ensure that the outputs of LLMs are reliable, up-to-date, and factual.

Current implementations of RAG systems typically break documents that populate a set of databases into chunks of raw text, which are then used as sources for question-and-answering and other applications. More specifically, these chunks are transformed into a vectorial representation (an embedding) with a language model, stored into a vector database and indexed. The language model used for embedding the chunks may be the same language model used to answer user queries. Typically, however, a lighter model (with fewer parameters) is employed to generate the embeddings. The chunks are stored with metadata indicating the original source document and/or other information.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of generating a curated dataset that includes question/answer (QA) pairs that each include a question, a squashed instruction, and an answer or RPI;

FIG. 2 discloses additional aspects of generating a curated dataset and illustrates a knowledge distillation phase and a feedback phase;

FIG. 3 discloses aspects of a user interface presented during the feedback phase;

FIG. 4 discloses aspects of an automatic verification operation performed on a generative system using the curated dataset; and

FIG. 5 discloses aspects of a computing device, system, or entity.

### DETAILED DESCRIPTION OF SOME EXAMPLE EMBODIMENTS

Embodiments disclosed herein generally relate to aligning generative systems and processes. More particularly, at least some embodiments relate to systems, hardware, software, computer-readable media, and methods for aligning generative systems and processes with user preferences and to evaluating generative systems and processes to measure alignment thereof with the user preferences.

Embodiments of the invention are discussed in the context of retrieval augmented generation (RAG) systems and question/answer or extraction applications. Embodiments of the invention, however, are not limited thereto and may be applied with generative systems generally and in the context of other applications, including LLM-based applications.

RAG systems are systems that enhance the ability of navigating enterprise-level content. RAG systems are able to add knowledge to existing generative systems without retraining the generative systems. Upon receiving a question, relevant information is searched and retrieved from indexed databases (information retrieval), and this information is then passed to a Large Language Model (LLM) to generate an answer (content generation). This approach allows LLM responses to account for fresh, up-to-date, and/or confidential information.

When a user submits a question to the RAG system, the submitted question is first embedded with the same language model used to embed the chunks. The embeddings are used to search for the most similar chunks in the vector database. Similarity in the vector space is typically computed with some distance function such as Euclidean distance, cosine distance, or the like. This process is referred to as semantic search because the embeddings encode semantic meaning.

From the top k most similar chunks, the associated documents (and/or any additional metadata) are retrieved by the retriever. These, in turn, are used to assemble the input and provide context for prompting the LLM. Typically, the input follows a template having some natural language instruction for the LLM, the question to be answered, and the document contents to be summarized or used.

RAG systems may vary, by way of example, in the choice of the language model for the embeddings, the chunking strategy used for source documents, the types of metadata associated with the chunks, how the documents associated with the chunks are accessed and processed, how the LLM input is assembled, and in the choice of the LLM itself.

Measuring the efficiency of RAG systems, however, is challenging. More specifically, RAG systems often include two main modules as previously stated: a retriever and a generator. The retriever retrieves documents based on the question and the generator generates a response based on the question and the retrieved documents. Achieving scalability and aligned efficiency measurements is difficult.

With regard to scalability, standard pattern matching approaches like ROUGE (Recall-Oriented Understudy for Gisting Evaluation) or BLEU (Bilingual Evaluation Understudy) rapidly falter in providing a reliable measure of a system's efficiency due to a phenomenon known as the curse of dimensionality. More specifically, these approaches fail to explore manifolds (connected regions with high density that can be described in lower dimensional space) in the output space. Consequently, these approaches of necessity span over all possible answer variations. Because the number of variations grows exponentially with output space dimensions, these approaches cannot scale to high dimensional spaces such as those available in typical computational representations of text information.

Scalability is relevant to efficiency measurement at least because scalability allows a holistic understanding of system behavior and enables observability over blind spots. The ability to understand system behavior enables modifications impacting system behavior to be traced, for example when performing continuous integration/continuous deployment (CI/CD) tests. Unfortunately, this is lacking in conventional systems.

Approaches to addressing scalability issues have various limitations. One approach to this problem is to collect human feedback. Human feedback is typically obtained by comparing outputs and picking the preferred solution. However, this type of human feedback requires new or novel evaluations every time the system is modified. Allocating several business experts to perform manual evaluation at every improvement cycle is not a viable solution due to its high cost and latency, which suggests a clear need for a more efficient solution.

Another approach to scalability concerns is to employ LLMs and other model-based evaluation methods to leverage on learned manifolds to address the exponential growth in the number of possible correct answers. This approach leads to alignment issues between the answer generated by the LLM and user preferences.

Measurements of system efficiency should be reliable and provide guidance on how to improve the RAG system with regard to user preferences. Conventional automated methods rely completely on LLMs to determine answer alignment. The reasoning behind this approach builds upon the alignment of LLMs with human preferences, which suggests that evaluations should also be aligned.

For example, some models generate measurements that are aligned to general audience preferences. These assessments, however, are only focused on general preferences and aligning the models to different preferences is challenging. More specifically, when focusing on information silos, the standard behavior of RAG systems is often inadequate. More specifically, most general-purpose RAG systems are designed to perform abstraction upon retrieved content (because general-purpose LLMs employed in generators are optimized this way). When performing abstractions, the retrieved content is manipulated to a new representation that is deemed more effective in each context (such as reasoning or extracting novel insights).

However, other users (e.g., business users) using RAG systems to break information silos may be interested in extractive capabilities, such that relevant and correct information is provided nearly as is to the user. Business content, for example, already contains the result of all reasoning in the document itself (e.g., competitive intelligence, strengths, produce/service limitations) and does not require further manipulation. In addition, business users are accountable for their choices and mostly prefer to perform reasoning for themselves rather than relying on black-box mechanisms subject to errors of various natures that are often difficult to be detected (e.g., hallucinations). As a result, the use of general-purpose LLMs for evaluation purposes does not align with business user preferences because the models are being optimized for a different purpose.

Aligning RAG systems or LLMs to novel or different preferences is a complex, time consuming, and financially demanding process. Using LLMs for automated efficiency evaluation is often unsatisfactory and is subject to uncontrolled and unknown systematic impacts due to imperfect alignment.

As previously stated, deriving reliable end-to-end efficiency measurements for RAG systems or RAG-based applications is challenging. Efficiency measurements include obtaining quality measurements for generated responses, including the correctness of an answer or response that accounts for answer alignment with a reference. This is relevant for understanding system behavior, implementing Continuous Integration (CI)/Continuous Deployment (CD) tests and making informed decisions for system development. Embodiments of the invention thus relate to providing reliable end-to-end correctness and/or efficiency measurements for RAG systems and RAG-based applications.

Reliable correctness measurements are provided in the context of a scalable solution in embodiments of the invention. By way of example, a scalable solution places statistical pressure towards good solutions as the system evolves. This allows the number of evaluations to grow as computational power becomes available. A scalable solution can be repeated and may automatically compute efficiency values or measurements as needed. This allows system progress to be traced across system modifications. In embodiments of the invention, computing efficiency values is not a demanding process and can be achieved with low latency. For example, efficiency measurements for a RAG system may be computed. After implementing changes to the RAG system, the efficiency measurements may be obtained. These efficiency measurements may illustrate progress in aligning the RAG system with final user preferences rather than conventional or general purpose preferences in one example.

Embodiments of the invention provide reliable correctness measurements that are aligned with user preferences. In one example, the correctness measurements provide insight as to how well the RAG system is aligning with specific or final user preferences. Embodiments of the invention do not rely on black box processes for determining computing efficiency and provide a way to control systematic effects in the evaluation process. Thus, embodiments of the invention allow and enable modifications to a RAG system such that final or desired user preferences are included or reflected in the modifications and outputs or answers generated by the RAG system.

Embodiments of the invention relate to a scalable system that is configured to place statistical pressure towards good or desired solutions as the system evolves such that the solutions are aligned with user preferences. This makes the system capable of growing the number of evaluations as more computational power becomes available. Scalability ensures the efficiency values can be computed as needed and provides a mechanism to trace system progress during modifications.

In addition to scalability, embodiments of the invention provide or generate a correctness efficiency measure that measures how the generative system is aligned with final user preferences. Embodiments of the invention relate to end-to-end reliable and scalable evaluation of LLM and/or RAG systems to measure or determine alignment thereof with final user preferences.

This is achieved, in part, by generating and curating a synthetic dataset that allows automatic efficiency and/or correctness computations/measurements to be performed efficiently and/or repeatedly.

In one example, referenced patterns of information (RPIs) are generated by distilling the knowledge of an LLM using models, such as aparametric models. Aparametric models are configured to capture possible answers. In one example, an RPI identifies a relevant and correct information aspect to be output by the RAG system for a particular input or question, or identifies that the RAG system is abstaining to provide an answer to the question. In one example, RPIs are regular expressions. An example RPI dedicated to identifying an affirmative answer could be: ‘\b(yes|certainly)\b’.

RPIs may be combined with or used in conjunction with a squashing instruction (SQI). More specifically, to ensure that RPIs are efficient in capturing answer variations, an automated process of generating questions and answers in a RAG system may include a squashing instruction configured to minimize or reduce the span of valid answers, which places statistical pressure on the processes. SQIs can be defined to maximize alignment with final user preferences. However, general purpose SQIs that can be broadly used for alignment of RAG systems with business preferences are also disclosed. An input/question that includes an SQI is an example of a squashed question (SQT).

Embodiments of the invention may also incorporate a human in the loop or human feedback. For example, a question and answer pair (QA pair) containing an SQT and RPI(s) may be subject to a curation process or operation. The curation process, which may alternatively be performed using machine learning, allows errors in the distillation process to be fixed or corrected to ensure that final user preferences are enforced or such that the RAG system is aligned with the final user preferences. Using a user interface, corrections/recommendations to the QA pairs. In other words, the QA pairs can be added, changed, deleted, or the like such that the RAG system aligns with final user preferences.

The curation process also enables reliable efficiency measurements to be obtained, in contrast to LLM-based verification operations. In one example, the knowledge distillation and feedback operation may be performed a single time. In addition, the human feedback is scalable.

A curated SQT together with corresponding RPIs, provides a way to automatically measure alignment of a response or answer generated by a RAG system to user preferences. In another example, the sources retrieved by the RAG retriever can be compared with the original sources of the LLM. This enables the efficiency of the retriever to be determined or measured. Embodiments of the invention provide computationally efficient and repeatable verification in the context of aligning a RAG system with final user preferences. The efficiency of the retriever and/or the generator or of the RAG system collectively can be determined.

Generally, verification is performed using the QA pairs (e.g., (question, instruction, answer) or (squashed question, RPI)) by receiving an SQT as input into a RAG system and allowing the RAG system to generate an answer. The correctness of the answer can be assessed using the RPI in the QA pair. More specifically, a fully correct answer includes all aspects indicated in the corresponding RPI or RPIs associated with the SQT. If only some of the RPIs are represented in the answer, the correctness may be reduced or scaled. In this manner, the answers generated in response to the QA pairs can be scored (e.g., penalty, reward). A cumulative or total score may be generated by summing the individual scores of the QA pairs. The cumulative score is an example of a measurement of how the RAG system is aligned with user preferences, which are reflected in the RPIs.

More specifically, the automated verification method uses the answer generated by the RAG system and the RPIs to generate or assign information bits that identify whether the output matched an RPI. The information bits allow a statistical score to be generated based on whether the answer matched an RPI (or RPIs). Scores from multiple QA pairs can be aggregated. This allows key performance indicators (KPIs) and other measurements to be determined or generated.

In one example, an end-to-end evaluation or verification method is disclosed. The method introduces RPIs and SQTs that allow system efficiencies to be automatically determined or measured. This is an improvement over black box approaches such as LLMs and standard matching approaches that cannot provide reliable measurements (due in part to the curse of dimensionality).

RPIs and SQTs (QA pairs) can be generated or derived through the distillation of LLM knowledge, resulting in a scalable approach. For example, additional QA pairs can be generated and/or used as more compute power becomes available. RPIs and SQTs can be aligned with final user preferences without training an LLM, thus directly obtaining a cheap reward function to guide the system development. RPIs provide an interpretable and simple way to represent what is relevant and required for an answer to be considered fully correct. The alignment evaluation can be repeated as many times as needed. The reward function can be easily adjusted whenever required by directly modifying RPIs and/or SQTs in the QA pairs. Thus, systematic effects during evaluation of the RAG system can be controlled by collecting human feedback during or after the generation of RPIs and SQTs. In one example, human feedback needs to be collected only once, but may be updated if desired. This is an improvement over other approaches that require feedback after every modification.

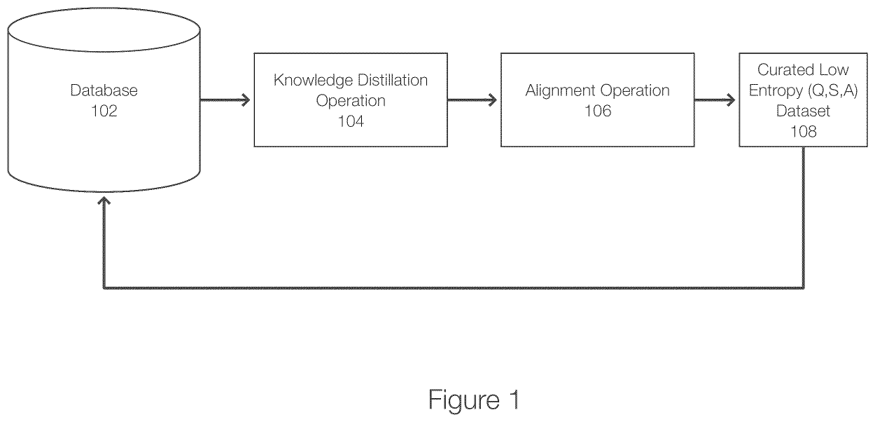

FIG. 1 discloses aspects of generating and/or curating a low entropy dataset, which may be configured for use in measuring efficiencies and/or alignment of a RAG system to final user preferences. FIG. 1 illustrates a database 102 that may include, by way of example, source documents for a generative system, such as an RAG system. Generating or curating the low entropy dataset includes performing a knowledge distillation operation 104 on the database 102 or sources stored therein. The knowledge distillation operation 104 is performed to generate question/input and answer/output pairs or QA pairs. The QA pairs are generated, in one example, by instructing an LLM to generate questions and answers from the database 102 (or portions or sources therein).

Next, an alignment operation 106 is performed to align the QA pairs with final user preferences. This may be performed without relying on LLMs in one example. This results in a curated low entropy dataset 108, which may be stored in the database 102 or in a separate storage.

More specifically, the knowledge distillation operation 104 distills LLM knowledge (e.g., the database 102) onto RPIs and/or introduces squashing instructions to the questions/inputs. The curated dataset 108 is represented by a form (Q, S, A), where Q is the question/input, S is the squashing instruction, and A is an RPI (or answer) in one example. In another example, the QA pairs in the curated dataset 108 may be represented as (SQT, RPI), where the SQT includes a question and a squashing instruction.

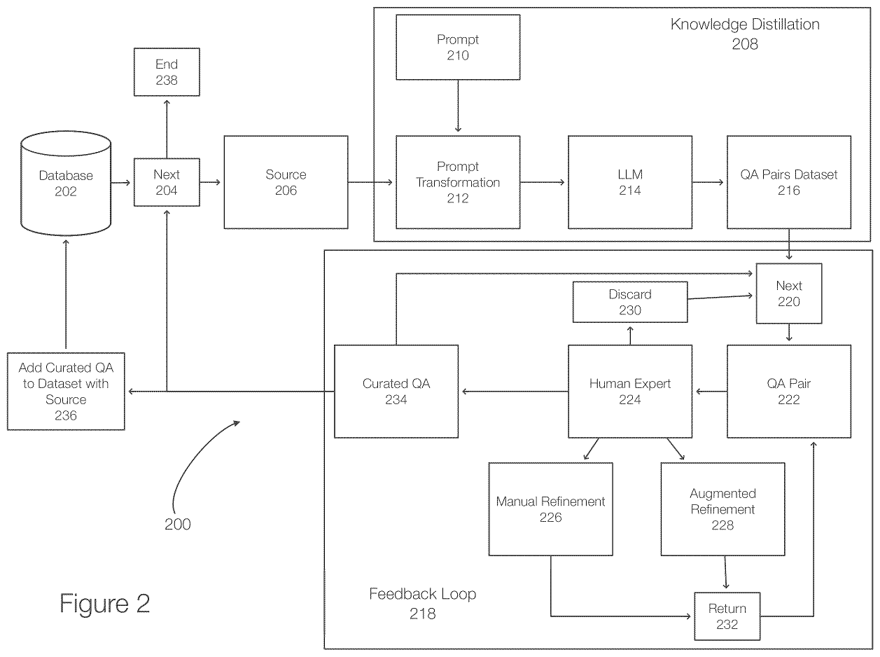

FIG. 2 discloses additional aspects of generating and/or curating a dataset. FIG. 2 illustrates a database 202 (e.g., knowledge added to a RAG system). Sources, such as the source 206 (e.g., a document or set of documents) are retrieved from the database 202 until all sources have been processed in the method 200 in one example. The next 204 block illustrates a decision block that allows the method 200 to iterate through the documents in the database 202. When all documents have been processed and the curated QA dataset is generated, the method 200 may end 238.

Alternatively, specific sources or documents may be processed. In one example, knowledge being added to an LLM (e.g., enterprise or private sources) are processed by the method 200.

The method 200 focuses on a source 206 or document. In this example, knowledge distillation 208 is performed on the source 206. Knowledge distillation 208 may be configured to generate QA pairs that may include SQTs and RPIs.

LLMs, such as the LLM 214, may be configured to generate QA pairs from the source 206. In this example, the prompt 210 (e.g., generate QA pairs from the source 206) is transformed (prompt transformation 212) such that the QA pairs being generated include SQIs and RPIs. In one example, the prompt transformation 212 may include a few shot approach, but embodiments are not limited thereto.

Rather than simply causing the LLM 214 to generate a reference answer to a generated question, the LLM 214 is employed to distillate its knowledge to aparametric models of possible answer patters or RPIs. A single RPI may be a template of pattern variations for the same reference data. In one example, regular expressions (regexp) are used to generate the RPIs.

A correct RPI (cRPI) identifies a relevant and correct information aspect to be output by a RAG system for a particular input or question. Because an answer can require multiple relevant and correct information aspects, a question may map to multiple cRPIs, one for each aspect required for the answer to be considered fully correct and relevant.

In one example, the cRPI provides a way to evaluate a quality dimension such as faithfulness when the RAG system has access to the original source. Faithfulness measures or reflects whether the generative system provides answers that are grounded on the information that has been retrieved.

An abstain RPI (aRPI) indicates that the RAG system is abstaining to provide an actual answer to the input question. In one example, an aRPI is not associated with questions, but identify system behaviors when abstaining to provide an actual output/answer to a given input/question. As a result, aRPIs are typically derived per LLM.

RPIs, in one example, are shallow aparametric models that are derived or determined by distilling LLM knowledge. This provides some benefits in terms of facing the curse of dimensionality with respect to standard parametric pattern matching approaches (like ROUGE or BLEU that are based on n-grams with a fixed number of possible patterns). The nature of ROUGE and BLEU hinders their ability to cover the full span of possible answers.

To address the curse of dimensionality, embodiments of the invention request the LLM to introduce an squashing instruction with the question/input. The role of the instruction is to collapse the output distribution towards a limited number of valid variations of correct answers. Instructions that collapse of output distributions of an LLM are examples of SQIs. From an information theory perspective, the entropy of the distribution of valid answers is reduced and is concentrated around of a few possible representations that are captured using cRPIs.

SQIs can be aligned to tasks of interest of the final user. As a result, generative processes that disregard squashing instruction specifications are violating use cases and, as a result, are not performing as intended. SQIs help ensure that the subset of output space under evaluation is of interest to the application/user and serves as a proxy for performing informed decisions for system optimization and alignment with final user preferences.

In the context of generating QA pairs, SQIs may be general or specific. An example of a general purpose SQI is “respond with an excerpt from the available context.” SQIs may thus focus on relevancy aspects by evaluating whether a generative system can extract all pieces of information deemed relevant for a given input.

Another SQI may be to “respond with a simply yes or no”. This type of SQI may be tied to evaluating particular properties of the generative system. This SQI allows system capability to be measured with respect to polarity (e.g., affirmative/negative). For example, this type of SQI may help determine whether the generative system can consult information in business documents without having to perform any abstraction and provide an affirmative or negative answer.

FIG. 2 this illustrates that QA pairs 216 are generated and that each QA pair includes a question, a squashing instruction, and an answer (Q, S, A). As previously stated, the question and squashing instruction may be represented as a SQT and the answer may be represented as an RPI.

A feedback loop 218 is performed on the QA Pairs 216 when the curated dataset is being generated. In this example, the feedback loop 218 is enhanced with human feedback that is provided by a human expert 224 (or other user). In this example, the next 220 QA pair is retrieved from the dataset 216 and processed in the feedback loop 218.

FIG. 2 thus illustrates an example QA pair 222 in the feedback loop 218. In this example, the QA pair 222 may be subject to one or more flows, which are illustrated by way of example and not limitation. The QA Pair 222 may follow a discard flow. If the QA pair 222 follows the discard flow, the QA pair 222 may be reviewed and discarded 230 for various reasons, such as an incorrect answer, not sufficiently correct answer, or the like. Once a QA pair is discarded, the QA pair may not be considered further and the feedback loop 218 proceeds to the next QA pair in the QA pairs dataset 216.

A refinement flow allows modifications to be provided to better capture relevant and correct aspects required for an answer to be correct. The refinement flow may include a manual refinement 226 in which the human expert 224 provides additional aspects to the QA pair 222. In augmented refinement 228, an LLM may be used to augment the QA pair 222.

The refinement flow may return the QA pairs for further processing or further human review 224.

In an accept flow, the curation of the QA pair 222 is completed and the human expert 224 is satisfied with the content of the QA pair 222. This allows the QA pair 222 to be added to the curated dataset.

When the QA pair 222 is curated, the curated QA pair is added 236 to the database 202, which is an example of a curated dataset. The source may also be identified for the QA pairs included in the curated dataset.

As illustrated, the feedback loop 218 is performed to capture what is required for an answer to be aligned with final user preferences. The feedback loop 218 augments the distillation of the source 206 performed by the LLM 214 to generate cRPIs, which allow relevant and correct answers to be described. The curated dataset allows evaluations of a RAG system to be performed as many times as required without additional feedback and without user input.

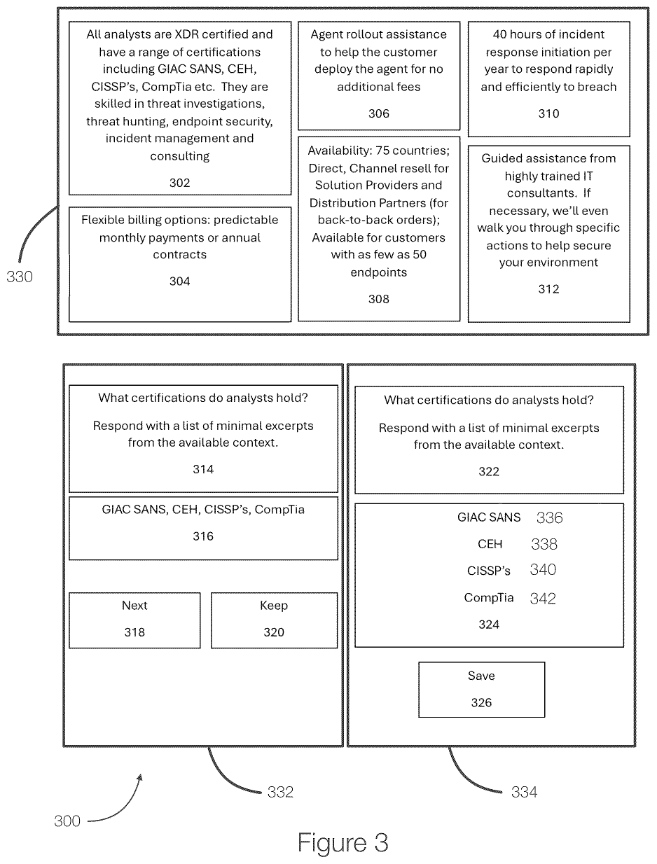

FIG. 3 illustrates an example of a user interface for collecting human feedback. A user interface 300 for facilitating user feedback (e.g., feedback loop 218) is illustrated. FIG. 3 illustrates a source 330 that may include documents 302, 304, 306, 308, 310, and 312. The source 330 may be presented to a human expert in a user interface. The QA pairs generated from the source 330 by distilling the source 330 may be presented in a window 332 of the user interface 300. In this example, a QA pair represented by an SQI 314 (includes question and squashing instruction) and an answer 316 or RPI. The user may work on (edit, alter, change) the QA pair in a window 334. The user may be able to review the sources and change the squashing instruction 322, the RPI 324, or the like. The same QA pair 314 and 316 are illustrated in the window 334 as QA pair 322 and 324.

More specifically, the user may be able to compare the RPI or answer 324 with the sources 330. If changes are required, changes may be made in the window 334 and saved 334. If saved and accepted, this represents an example of the accept flow. Once the QA pair is curated, a user may proceed to a next QA pair via the next button 318. If no changes are needed, the QA pair may be kept 320. The QA pair may also be subject to refinement.

In this example, the answer 324 includes or is associated with 4 RPIs (RPIs 336, 338, 340, and 342). Each RPI represents a correct aspect of the answer 324. Thus, for an answer to this question to be fully correct, all RPIs 336, 338, 340, and 342 should be represented in the answer.

During automated verification (e.g., to measure or determine alignment of the RAG system to final user preferences), the curated dataset of QA pairs may be used. In one example, the questions/instructions are input to a RAG system and the output is compared to the RPI in the curated QA pair. If the RAG system generates an answer that does not include all of answer aspects represented or included in the RPIs, the answer may be incorrect or partially correct and the reward generated during verification reflects the level of correctness.

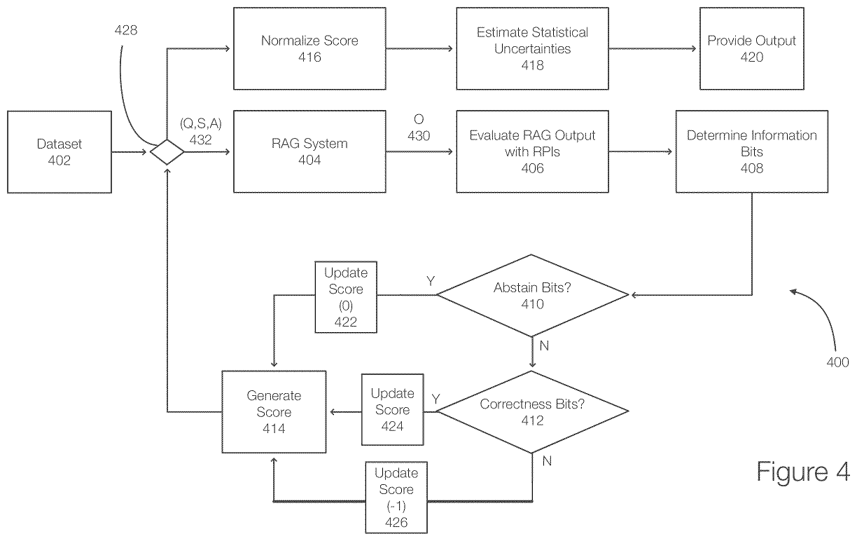

FIG. 4 discloses aspects of an automated verification method for verifying or measuring an efficiency of a generative system, such as a RAG system. FIG. 4 thus illustrates an automated verification method 400. The method 400 may be performed without user input in one example and may be performed repeatedly. Performing the verification method 400 repeatedly over time allows improvements in alignment to user preferences to be tracked as modifications are made to the RAG system.

In FIG. 4, the decision block 428 represents a decision block. For example, after processing a QA pair, another QA pair is retrieved from the dataset 402. This may continue until all QA pairs (or a predetermined number of QA pairs) have been processed in the method 400. Thus, once a score is generated 414 for a QA pair, the next QA pair is processed. In some examples, QA pairs may be processed in parallel using one or more instances of the method 400.

When all QA pairs have been considered by the method 400, the output 420 (e.g., a final alignment score) is output 420. This may include normalizing 416 the scores based on the number of questions and/or estimating 418 statistical uncertainties.

The method 400 is performed for each QA pair in the dataset 402 and operation of the method is explained for a specific QA pair. In this example, a QA pair 432 (e.g., (Q, S, A) or (SQT, RPI)) is input to a RAG system 404. More specifically, the question (and/or squashing instruction) is input to the RAG system 404. The RAG system 404 generates an answer or output 430 (O). The output 430 of the RAG system 404 is evaluated 406 in light of the RPI(s) of the QA pair 432. Stated differently, the aparametric model(s) or RPIs in the QA pair are applied to or compared with the output 430.

Evaluating the output 430 may include determining information bits 408 for the output 430. The number of information bits for a QA pair may vary and may depend on the number of RPIs associated with the QA pair. Information bits 408 may include correctness bits and abstain bits. In one example, correctness bits are set (e.g., set to 1) if the output 430 matches or complies with an RPI. If the QA pair is mapped to or associated with multiple RPI models, multiple correctness bits may be set. Thus, if the QA pair 432 is associated with four RPIs, there are four correctness bits that may be set based on whether the output 430 includes or complies with the RPIs. For example, and with reference to FIG. 3, the RAG system may return a response of CEH and CISSP's in response to the question “What certifications do analysts hold?” The answer would be partially correct and receive a score of 0.5 (2 out of four) because only 2 of the 4 associated RPIs are present in the answer.

The information bits may also include abstain bits. An abstain bit is set (e.g. set to 1) if the output 430 indicates that the RAG system 404 abstains from answering the question.

Once the information bits are determined 408, the information bits are evaluated and converted to a score. The score represents how aligned the RAG system is to the final user preferences reflected in the curated dataset. In this example, if an abstain bit is present (Y at 410), a score of zero (0) (update score 422) is return for the QA pair 432. When an abstain bit is present, the alignment score is not penalized.

The overall or running score (e.g., a cumulative score for all QA pairs) may also be updated by adding 0 to the score in this example.

If an abstain bit is not present (N at 410), the correctness bits are evaluated. If correctness bits are present (Y at 412), a ratio of retrieved correctness bits to total possible correctness bits for the QA pair 432 is determined and the score is updated 424 with this ratio. thus, the overall alignment score is rewarded based on the correctness of the output 430. This score may also be added to the cumulative score. If correctness bits are not present (N at 412), a score of (−1) is applied and the score is updated 426 as previously described. This penalizes the system for generating an output 430 that is incorrect.

Thus, for each QA pair in the dataset 402, scores are generated 414 for each QA pair and/or for all QA pairs cumulatively. The cumulative or summed score is an example of an alignment measurement or final alignment score.

The final alignment score may be a sum of the QA rewards and penalties normalized 416 by the number of QA pairs in the dataset 402. This is an example of a calibrated KPI (cKPI). The final alignment score or output 420 may be associated with a statistical uncertainty value 418.

### Experiment

In one example, a low entropy dataset was generated from 32 competitive intelligence documents (58 slides). Generating the curated dataset resulted in a total of 91 curated (Q, S, A) QA pairs. The samples were curated by researchers (not final users) to test the system capabilities to align with final user preferences. In this example, the tasks performed by the RAG system are extractive in nature. As a consequence, the curation process is not expected to differ significantly from final user preferences.

From these 91 QA pairs:
Fifty-eight (58) QA pirs use general-purpose instructions dedicated to relevancy aspect (e.g., respond with an excerpt of the available context);
The remaining thirty-three (33) QA pairs cover an answer polarity aspect (e.g., respond with a simple ‘yes’ or ‘no’) on top of inputs consulting information as provided in the documents, where 19 of the QA pairs require affirmative answers and 14 of the QA pairs require negative answers.

This curated dataset was used to verify the efficiency of two RAG systems: (i) a system (JARVIS) composed of complex retrieval and generator modules that inherits all knowledge acquired so far and (ii) a simple generator module with perfect retrieval (Clean Baseline) that is instructed to follow SQIs whenever they are present.

This evaluation identified the following insights.

The first insight is an efficiency bottleneck. A major efficiency bottleneck (approximately a decrease in cKPI of −50±9 percentual points) in JARVIS system occurs due to the injection of noise by the retriever module and a lack of lack of noise robustness in the generator.

This insight, however, is a major improvement with respect to other strategies. Previous methods based on manual evaluation did not provide a way to understand major system bottlenecks. Automated methods failed to provide measurements that aligned with business requirements. This insight allows modifications to be made. Efficiency can be measured using the same curated dataset after making the modifications to the RAG system.

This experiment also demonstrated a systemic impact of a squashing instruction. JARVIS behaved worse when an SQI is introduced in the input with respect to a question without the SQI (−9.4±10.0 p.p). The Clean Baseline demonstrated an opposite behavior (+9.1±7.9 p.p.). Beyond other factors, the major contribution for JARVIS behaving worst was systematic migration to negative answers (20 migration instances to a negative answer against 1 migration instance to an affirmative answer). Because the systems are different due to noise injection, the JARVIS behavior occurs due its output convergence to the marginal distribution of the training dataset (in this case, no) when it cannot encounter information to put pressure towards the correct polarity.

The strength of embodiments of the invention to ensure consistency of the model behavior (i.e., providing higher efficiency at lower complexity tasks (such as when SQI is introduced, therefore reducing the span of the output space).

The experiment also demonstrated that automated verification improves with respect to manual verification.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, automated verification operations, efficiency operations, alignment operations, curation operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects. An object may be a portion of a document image.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1.A method performing automated verification in a generative system by, for each question/answer (QA) pair in a dataset: inputting a QA pair into the generative system, the QA pair including a question and at least one referenced pattern of information (RPI), evaluating an answer of the generative system in response to the question in the QA pair, and generating a score for the QA pair based on a comparison of the answer generated by the generative system to the at least one RPI, and generating a cumulative score that includes scores for all of the QA pairs in the dataset, wherein the cumulative score represents an alignment of the generative system to final user preferences.

Embodiment 2.The method of embodiment 1, further comprising determining information bits for the answer and setting a correctness bit for each of the at least one RPI associated with the QA pair found in the answer.

Embodiment 3.The method of embodiment 1 and/or 2, further comprising setting an abstain bit when the answer represents abstaining.

Embodiment 4.The method of embodiment 1, 2, and/or 3, further comprising assigning a score that does not penalize the generative system when the abstain bit is set.

Embodiment 5.The method of embodiment 1, 2, 3, and/or 4, further comprising assigning a maximum penalty score when the abstain bit is not set and no correctness bits are set.

Embodiment 6.The method of embodiment 1, 2, 3, 4, and/or 5, further comprising assigning a reward score that is a ratio of a number of correctness bits set to total possible correctness bits for the answer.

Embodiment 7. The method of embodiment 1, 2, 3, 4, 5, and/or 6, further comprising summing scores for the QA pairs to generate the cumulative score, wherein the cumulative score is normalized.

Embodiment 8. The method of embodiment 1, 2, 3, 4, 5, 6, and/or 7, further comprising creating the QA dataset by distilling knowledge of the generative system or from a source into the QA pairs, wherein each of the QA pairs includes a question, a squashing instruction, and an RPI.

Embodiment 9. The method of embodiment 1, 2, 3, 4, 5, 6, 7, and/or 8, wherein the squashing instruction is configured to reduce a span of correct answers within an output space.

Embodiment 10. The method of embodiment 1, 2, 3, 4, 5, 6, 7, 8, and/or 9, further comprising performing a feedback loop on the QA pairs, wherein the QA pairs are curated during the feedback loop.

Embodiment 11. The method of embodiment 1, 2, 3, 4, 5, 6, 7, 8, 9, and/or 10, wherein the feedback loop includes a discard flow, a refinement flow, and an accept flow that are performed based on user feedback.

Embodiment 12. The method of embodiment 1, 2, 3, 4, 5, 6, 7, 8, 9, 10, and/or 11, wherein the QA pairs in the dataset are configured to align the generative system to final user preferences, wherein the generative system comprises a retrieval augmented generation (RAG) system.

Embodiment 13. A system, comprising hardware and/or software, operable to perform any of the operations, methods, or processes, or any portion of any of these, disclosed herein.

Embodiment 14. A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

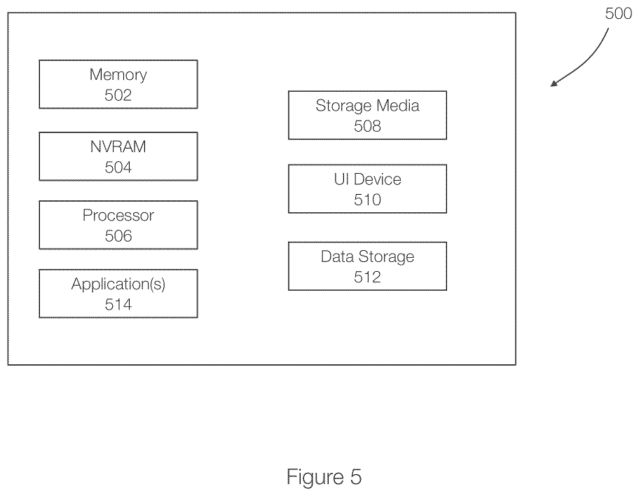

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

The device 500 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may also represent a physical or virtual machine or server, an edge-based computing system, a cloud-based computing system, server clusters or other computing systems or environments. The device 500 may also represent multiple machines or devices, whether virtual, containerized, or physical. The device 500 may perform or execute steps or acts of the methods illustrated in the Figures.

The device 500 may represent a cloud-based system, an edge-based, system, an on-premise system, or combinations thereof. Curation operations, alignment operations, verification operations, user interface related operations, or the like may be performed using these types of computing environments/systems.

The described embodiments are to be considered in all respects only as illustrative and not restrictive. All changes which come within the meaning and range of equivalency of the claims are to be embraced within their scope.

What is claimed is:

1. A method comprising:
performing automated verification in a generative system by, for each question/answer (QA) pair in a dataset:
inputting a QA pair into the generative system, the QA pair including a question and at least one referenced pattern of information (RPI);
evaluating an answer of the generative system in response to the question in the QA pair; and
generating a score for the QA pair based on a comparison of the answer generated by the generative system to the at least one RPI; and
generating a cumulative score that includes scores for all of the QA pairs in the dataset, wherein the cumulative score represents an alignment of the generative system to final user preferences.

2. The method of claim 1, further comprising determining information bits for the answer and setting a correctness bit for each of the at least one RPI associated with the QA pair found in the answer.

3. The method of claim 2, further comprising setting an abstain bit when the answer represents abstaining.

4. The method of claim 3, further comprising assigning a score that does not penalize the generative system when the abstain bit is set.

5. The method of claim 3, further comprising assigning a maximum penalty score when the abstain bit is not set and no correctness bits are set.

6. The method of claim 3, further comprising assigning a reward score that is a ratio of a number of correctness bits set to total possible correctness bits for the answer.

7. The method of claim 6, further comprising summing scores for the QA pairs to generate the cumulative score, wherein the cumulative score is normalized.

8. The method of claim 1, further comprising creating the QA dataset by distilling knowledge of the generative system or from a source into the QA pairs, wherein each of the QA pairs includes a question, a squashing instruction, and an RPI.

9. The method of claim 8, wherein the squashing instruction is configured to reduce a span of correct answers within an output space.

10. The method of claim 8, further comprising performing a feedback loop on the QA pairs, wherein the QA pairs are curated during the feedback loop.

11. The method of claim 10, wherein the feedback loop includes a discard flow, a refinement flow, and an accept flow that are performed based on user feedback.

12. The method of claim 10, wherein the QA pairs in the dataset are configured to align the generative system to final user preferences, wherein the generative system comprises a retrieval augmented generation (RAG) system.

13. A non-transitory storage medium having stored therein instructions that are executable by one or more hardware processors to perform operations comprising:
performing automated verification in a generative system by, for each question/answer (QA) pair in a dataset:
inputting a QA pair into the generative system, the QA pair including a question and at least one referenced pattern of information (RPI);
evaluating an answer of the generative system in response to the question in the QA pair; and
generating a score for the QA pair based on a comparison of the answer generated by the generative system to the at least one RPI; and
generating a cumulative score that includes scores for all of the QA pairs in the dataset, wherein the cumulative score represents an alignment of the generative system to final user preferences.

14. The non-transitory storage medium of claim 13, further comprising determining information bits for the answer and setting a correctness bit for each of the at least one RPI associated with the QA pair found in the answer and/or setting an abstain bit when the answer represents abstaining.

15. The non-transitory storage medium of claim 14, further comprising assigning a score that does not penalize the generative system when the abstain bit is set, assigning a maximum penalty score when the abstain bit is not set and no correctness bits are set, or assigning a reward score that is a ratio of a number of correctness bits set to total possible correctness bits for the answer.

16. The non-transitory storage medium of claim 15, further comprising summing scores for the QA pairs to generate the cumulative score, wherein the cumulative score is normalized.

17. The non-transitory storage medium of claim 13, further comprising creating the QA dataset by distilling knowledge of the generative system or from a source into the QA pairs, wherein each of the QA pairs includes a question, a squashing instruction, and an RPI.

18. The non-transitory storage medium of claim 17, wherein the squashing instruction is configured to reduce a span of correct answers within an output space.

19. The non-transitory storage medium of claim 18, further comprising performing a feedback loop on the QA pairs, wherein the QA pairs are curated during the feedback loop.

20. The non-transitory storage medium of claim 18, wherein the feedback loop includes a discard flow, a refinement flow, and an accept flow that are performed based on user feedback, wherein the QA pairs in the dataset are configured to align the generative system to final user preferences, wherein the generative system comprises a retrieval augmented generation (RAG) system.
